(19) United States
(12) Patent Application Publication
(10) Pub. No.: US 2012/0171372 A1
(43) Pub. Date: Jul. 5, 2012

(54) AUTOMATIC SHUTTER FOR ADHESIVE DISPENSER

(75) Inventors: Hk Looi, Singapore (SG); Cheng-hai Cheh, Singapore (SG)

(73) Assignee: STMICROELECTRONICS PTE LTD., Singapore (SG)

(21) Appl. No.: 12/982,755

(22) Filed: Dec. 30, 2010

(51) Int. Cl. B05D 5/10; B05C 11/00; B05C 5/00

(52) U.S. Cl. 427/207.1; 118/300

(57) ABSTRACT

In automated gluing systems for semiconductor device manufacture, an automatic shutter system is provided for use with an adhesive dispenser that is configured to deposit adhesive for joining elements during final assembly processes. A shutter is configured to interpose itself between a needle tip of the dispenser and a working surface, on which devices in process are positioned, while the dispenser is in a ready position and not actually delivering adhesive, and to withdraw from the interposed position as, or immediately before the needle tip descends to a dispensing position to deposit adhesive on a device. In this way, drops of adhesive that fall from the needle tip while in the ready position are captured by the shutter and prevented from falling onto a device in process in an unintended location of the device.

### BACKGROUND OF THE INVENTION

1. Technical Field

This disclosure is related generally to the field of adhesive dispensing systems, and in particular to systems for dispensing adhesives in automated assembly systems where the position and volume of the dispensing are critical, including systems for assembly and packaging of semiconductor based devices, and electronic devices in general.

2. Description of the Related Art

A number of different types of adhesives are commonly used in the “back end” processes of semiconductor device manufacture, and in assembly of electronic devices. Examples include thermally conductive adhesives used to mechanically bond semiconductor dice to lead frames and to transmit heat to the lead frames; adhesives used to hermetically seal covers onto microelectromechanical devices formed on semiconductor wafers; adhesives used to attach lenses to semiconductor dice over optical sensors; solvent adhesives used to assemble plastic components; elastomeric adhesives to join components and dampen vibrations between the components, etc. Very often, adhesives must be deposited with great precision to avoid damaging the devices being bonded. In most cases, these adhesives are applied onto one of the surfaces to be bonded by automatic dispensers as part of an automated assembly process. Misplacement of such adhesives can often cause cosmetic or substantive damage to a device that will render the device unsalable.

One example of an automated adhesive dispensing system is shown in FIGS. 1 and 2, which are diagrammatic representations of a known adhesive dispensing system 100 for applying adhesive around the perimeters of optical sensors. The adhesive is used to bond lenses over the sensors, for use in small cameras such as, e.g., cell phone cameras.

The dispensing system 100 is part of a robotic assembly system for packaging semiconductor devices, and is carried by a first robotic arm 102 of the assembly system. The assembly system also includes a second robotic arm 120 that carries a placing fixture 124 for placing lenses 126, which is shown in FIG. 2 for context. The first robotic arm 102 carries a support fixture 103 to which an adhesive dispenser 104 and a fiducial camera 116 are coupled. The first arm 102 and fixture 103 cooperate to move the dispenser 104 in the X, Y, and Z axes. In some cases, the arm 102 is movable in two axes, but typically, the arm is in the form of a gantry that transports the support fixture 103 in the X axis over a working surface of the system, while the fixture is in the form of a carriage that carries the dispenser 104 and moves in the Y axis along the arm, and the dispenser moves in the Z axis relative to the fixture and the arm.

The adhesive dispenser 104 comprises a dispenser body 105 and a nozzle 107 that includes a needle tip 106. The dispenser 104 is configured, in the example shown, to deposit adhesive onto semiconductor dice 110 in which optical sensors 112 have been formed. The fiducial camera 116 is configured to detect fiducial marks on each die 110. The dice 110 are mounted in quantities of about 50-100 on a carrier 114, sometimes referred to as a stiffener, having a size of about 400-1000 cm². The carrier 114 is moved though various stages of the assembly process by a transport system, which is not shown.

The second robotic arm 120 carries a second support fixture 122 to which a component placement device 124 is coupled for placing the lenses 126.

In the stage depicted in FIGS. 1 and 2, the carrier 114 is brought into a fixed position under the arm 102 where it stays until completion of the stage. Once the carrier 114 is in position, the system goes into an acquisition mode, in which the first arm 102 and support fixture 103 move back and forth across the carrier 114 while the camera 116 scans the surface of each die 110 to read the fiducial marks and determine the precise location and orientation of each optical sensor 112. During this detection and location step of the process, the adhesive dispenser 104 is held by the support fixture 103 in a ready position, as shown in FIG. 1, in which the needle tip 106 is retracted a short distance from the die 110. Once all the sensors have been located, the system goes into a dispensing mode, in which the support fixture 103 moves the dispenser 104 in the Z axis to a dispensing position, bringing the needle tip 106 of the nozzle 107 into contact or near contact with a top surface of a first one of the die 110, as shown in FIG. 2. The arm 102 and fixture 103 cooperate to move the dispenser 104, which deposits a bead of adhesive or a series of adhesive dots around the perimeter of the sensor 112. The arm 102 and support fixture 103 again move back and forth across the carrier 114, this time moving the dispenser to deposit adhesive around the sensor 112 of each of the die 110. As the dispenser 104 finishes with one die 110 and is moved to the next, the dispenser 104 is not returned to the ready position, but is lifted from the dispensing position only far enough to ensure that the needle tip 106 will not make contact with any die 110 or other element that it might pass over as it moves. When adhesive has been placed on every die 110, the dispenser 104 is returned to the ready position and the second robotic arm 120 carries the second support fixture 122 and component placement device 124 to deposit a lens 126 over each of the optical sensors 112 in a pick-and-place operation, on top of the previously deposited adhesive. The carrier 114 is then transported to a curing station while a new carrier is moved into position.

It is important that the deposition of the adhesive be precisely controlled both in terms of volume and location. When the lens 126 is placed over the adhesive, capillary action of the fluid adhesive between the lens and the surface of the semiconductor die 110 draws the lens into close contact with the die, with only a thin film of adhesive between the lens and the die. If too much adhesive is deposited, it will flow onto the surface of the optical sensor, which will ruin the device, while too little adhesive will not properly bond the lens to the die. If the adhesive is not positioned correctly, it will either fail to contact the lens along one or more edges, or will again flow onto the sensor.

Additionally, the adhesive is preferably very thin, having a viscosity approaching that of water. If the adhesive is too viscous, it can fail to flow properly when the lens is positioned, leaving an uneven surface, so that the lens is out of plane. Furthermore, adhesive viscosity controls the thickness of the film between the lens and the surface of the die, which in turn controls the distance of the lens from the sensor. Thus, if the adhesive is too viscous, the lens will be seated farther from the sensor, and the focal length will be adversely affected.

In order to adequately control the adhesive deposition, the needle tip 106 of the adhesive dispenser 104 is very fine, having a bore, typically, of around 150-250 μm. Dispensers typically employ one of two types of mechanisms to meter the adhesive. One class of dispensers employ mechanical control, such as by a screw-driven plunger, in which movement of a plunger in the body of the dispenser forces fluid out the tip 106. Rotation of a drive screw advances the plunger within a syringe to force fluid from the needle tip. Control of fluid volume can be very precise because each rotation or fractional rotation of the screw moves the plunger a known distance, displacing a calculable volume within the syringe, and forcing an equal volume of fluid adhesive from the nozzle.

The other class of dispensers uses pneumatic pressure behind the adhesive in the dispenser to force fluid through the tip 106. Pneumatic dispensers are not as inherently precise as screw-driven dispensers because gas is compressible, so that for a given volume of gas moved into the dispenser it is not inherent that an equal volume of adhesive will be dispensed. Nevertheless, pneumatic dispensers can be precisely controlled, provided factors such as the viscosity and rheology of the adhesive, and the bore and length of the needle tip, are accounted for. Pneumatic dispensers are usually less expensive, and maintenance is easier and faster. However, in general, mechanically controlled dispensers are preferred for very low viscosity adhesives, because fluid flow can be closely and directly controlled, making it easier to maintain the flow of adhesive through the nozzle to within tolerances.

### BRIEF SUMMARY

In automated adhesive systems for semiconductor device manufacture, an automatic shutter system is provided for use with an adhesive dispenser system that is configured to deposit adhesive for joining elements during final assembly processes. According to an embodiment, an arm is coupled to the adhesive dispenser system so as to be movable relative to the adhesive dispenser. The arm carries a shutter that it moves between a closed position, in which the shutter is interposed between a nozzle of the adhesive dispenser and a working surface, and an open position, in which the shutter is not interposed between the nozzle and the working surface.

Operation of the arm and shutter is controlled so that the shutter is moved to the closed position while the dispenser is in a ready position and not actually delivering adhesive, and to the open position as, or immediately before the needle tip descends to a dispensing position to deposit adhesive on a device. In this way, drops of adhesive that fall from the needle tip while in the ready position are captured by the shutter and prevented from falling onto a device in process in an unintended location of the device.

A number of different structures of the shutter system are shown and described, according to respective embodiments.

### BRIEF DESCRIPTION OF THE SEVERAL VIEWS OF THE DRAWINGS

FIGS. 1 and 2 are side views of an adhesive dispenser system according to known art, in diagrammatic form, in, respectively, a ready position and a dispensing position.

FIGS. 3A and 3B are side views of an adhesive dispenser system with a shutter system according to one embodiment, presented in diagrammatic form, in, respectively, a ready position and a dispensing position.

FIGS. 4A and 4B are side views of an adhesive dispenser system with a shutter system according to another embodiment, presented in diagrammatic form, in, respectively, a ready position and a dispensing position.

FIGS. 5A and 5B are views of an adhesive dispenser system with a shutter system according to another embodiment, presented in diagrammatic form, in which FIG. 5A is a side view of the adhesive dispenser system in a ready position, and FIG. 5B is a front view of the system of FIG. 5A, in dispensing position.

FIGS. 6A and 6B are side views of an adhesive dispenser system with a shutter system according to another embodiment, presented in diagrammatic form, in, respectively, a ready position and a dispensing position.

FIG. 6C is a cross-sectional diagrammatic view of a portion of the shutter system of FIG. 6A, taken along lines 6C-6C.

FIGS. 7A and 7B are side views of an adhesive dispenser system with a shutter system according to another embodiment, presented in diagrammatic form, in, respectively, a ready position and a dispensing position.

FIGS. 8A and 8B are side views of an adhesive dispenser system with a shutter system according to another embodiment, presented in diagrammatic form, in, respectively, a ready position and a dispensing position.

### DETAILED DESCRIPTION

With regard to the screw-driven adhesive dispensing systems referred to in the background, the inventors have found that there are problems associated with such systems that can interfere with their efficient operation. In the dispenser of these systems, the screw-driven plunger is powered by an electric motor. In high-speed production environments, the motor operates at an increased duty cycle, generating increased heat, which warms the adhesive in the dispenser. While the adhesive is typically a two-part adhesive that cures by catalysis, heat accelerates this process. Thus, the adhesive can begin to cure while still in the dispenser. This results in a more viscous adhesive, which can affect the final product, as discussed with reference to example described in the background. Additionally, the more viscous adhesive requires greater force to dispense through the very small needle tip, which increases the load on the motor, requiring more power, and generating more heat, while restricting fluid flow. Ultimately, in the worst case, the needle tip can become completely blocked, so that no adhesive is dispensed. When this occurs, the system can continue in operation without depositing adhesive, so that the lenses are placed on a dry surface. In some cases, such a condition can continue for some time before being discovered, resulting in a significant amount of rework or ruined product.

One solution is to use a pneumatically pressurized dispenser, which eliminates the heating problem. While such dispensers require care in controlling fluid flow during operation, the inventors believe that it is a generally viable solution. Unfortunately, the inventors have encountered another problem that can occur, most frequently in association with pneumatically pressurized systems, although mechanically pressurized systems are not immune.

As noted above, to achieve precise positioning of adhesives, many adhesive dispensing systems use optical pattern recognition systems that scan the surface of each die to locate fiducials to ensure that the deposit of adhesive is correctly positioned and oriented. As the camera moves back and forth over the dice on the carrier to determine the position and orientation of each of the sensors, a drop of adhesive can drip from the needle tip of the dispenser. If it lands on one of the sensors, it will ruin that device, because, even if it were discovered immediately, it could not be wiped away without damage to the sensor. Furthermore, such drops are generally miniscule, and nearly impossible to detect by visual inspection, so they are usually not discovered until after the devices go through several additional packaging and assembly steps, when the sensors are tested. In functional tests, a drop appears to be a group of dead cells, producing a black spot on an image, resulting in rejection of the entire part, both the lens and the die. Thus, not only are the semiconductor device and lens discarded, but the additional time and materials thereafter expended to move that device toward completion were also wasted. Nevertheless, the expense of losses due to adhesive drips, which are relatively rare, is significantly less than losses arising from premature curing of adhesive caused by parasitic heat. To the extent that damage caused by adhesive drips may have been previously recognized as a problem, it appears that manufacturers have been willing to accept them as an additional production cost. However, most manufacturers continue to employ screw-driven systems for applications that require low-viscosity adhesives and a high degree of control over volume and placement.

The inventors believe that damage caused by adhesive drips can be substantially reduced or eliminated using a simple and inexpensive mechanism, various embodiments of which are described below.

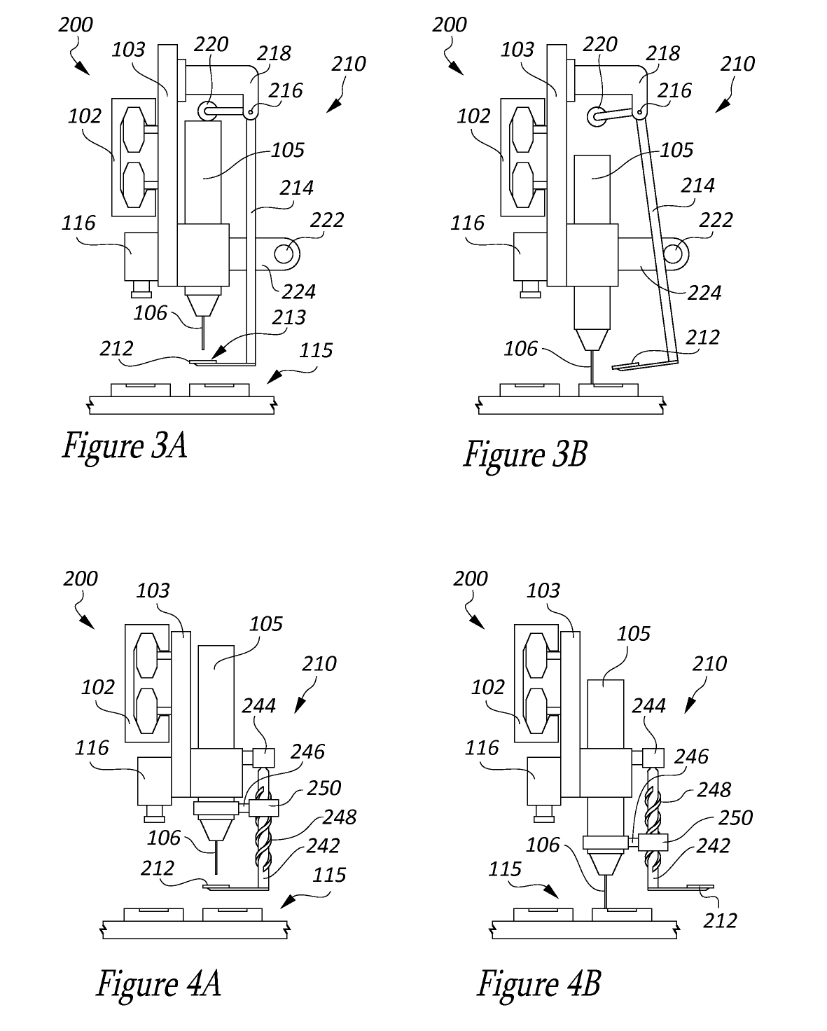

FIGS. 3A and 3B are diagrammatic representations of an adhesive dispenser system 200 according to a first embodiment. Many of the elements are substantially identical to corresponding elements described with reference to the prior art, and so will not be described in detail, and will be indicated by the same reference numbers.

In addition to elements previously described, the dispenser system 200 includes a shutter system 210 that is configured to interpose a shutter 212 between the needle tip 106 and the working surface below except while the dispenser 104 is in the process of dispensing adhesive. The shutter system 210 comprises a pivot arm 214 that is rotatably coupled to a first support bracket 218 at a pivot point 216, the support bracket serving to couple the pivot arm to the support fixture 103. A bumper 220 is coupled to a first end of the pivot arm 214, and bears against an upper surface of the dispenser body 105 while the dispenser 104 is in the ready position, as shown in FIG. 3A. The shutter 212 is coupled to a second end of the pivot arm 214. A second support bracket 224 is coupled to the support fixture 103 and supports a stopper pin 222 that extends across a plane of rotation of the pivot arm 214, limiting the range of rotation of the arm.

While the dispenser 104 is in the ready position, as shown in FIG. 3A, the bumper 220 of the pivot arm 214 bears against the upper surface of the dispenser body 103, thereby holding the pivot arm in a closed position, as shown, in which the shutter is interposed between the needle tip 106 and a working surface 115. Thus, while the dispenser system 200 is operating in the acquisition mode, for example, traversing back and forth across the working surface to detect fiducials, the shutter 212 is positioned directly beneath the outlet of the needle tip 106. Any adhesive that drips from the needle tip will strike the shutter 212 rather than falling to the working surface. When the dispenser system 200 switches to dispenser mode, the dispenser body 105 is lowered by the support fixture 103 to deposit adhesive on the product in process. As the dispenser body 105 drops, the bumper 220 is no longer supported by its upper surface, so the pivot arm 214 rotates outward, drawing the shutter 212 out from below the needle tip 106 as the tip drops toward the working surface. The pivot arm 214 rotates around the pivot point 216 until it is arrested by the stop pin 222 in an open position, as shown in FIG. 3B, where it remains while the system 200 is in dispenser mode. When the dispenser 104 is returned to the ready position, the dispenser body 105 contacts the bumper 222 as the body is raised, and pushes the bumper upward, causing the pivot arm 214 to rotate back to the closed position, in which the shutter 212 is again positioned under the needle tip 106.

In dispenser systems that are used in high-speed production, movement of the dispenser body 105 from the ready position to the dispensing position can be extremely fast, and in some cases, might exceed the speed at which the pivot arm 214 can rotate the shutter 212 out of the path of the descending needle tip 106. Responsiveness of the pivot arm 214 can be modified by adjusting the balance of the arm. If additional weight is added to the pivot arm 214 at or near the bumper 222, the arm will more quickly rotate away from the closed position, as the added weight more quickly overcomes static friction at the pivot point, and the vector of force acting to rotate the arm becomes more vertical. However, if the dispenser moves at speeds that approach or exceed the acceleration of gravity, it can become impossible for a gravity-operated pivot arm to move with sufficient speed. In such cases, one or more springs can be employed to reduce response time. For example, a torsion spring positioned at the pivot point 216 and configured to bias the pivot arm toward the open position will increase the speed of response of the pivot arm 214.

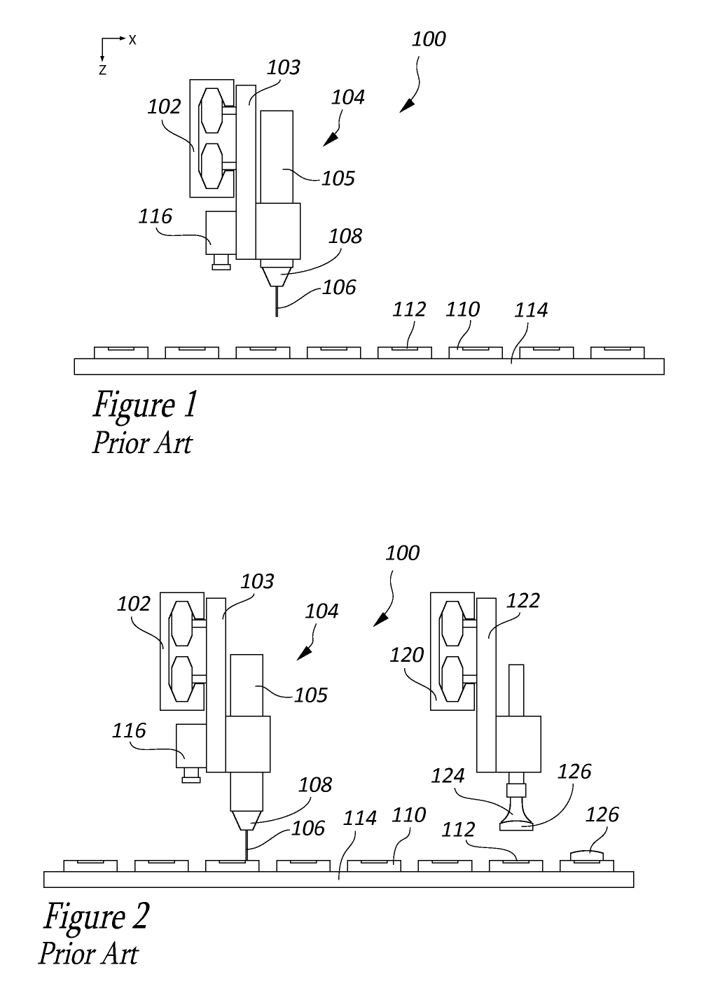

In a dispenser system like the one described with reference to FIGS. 1 and 2, in which the bore of the needle tip 106 has a diameter on the order of 200 μm, the volume of individual drops is generally miniscule. Thus, even if an upper surface 213 of the shutter 212 is flat, adhesive fluid that drips onto the surface will harden long before it can run off the edge of the shutter. Nevertheless, according to some embodiments, the upper surface 213 is dished to form a depression to receive drips from the tip 106. This provides an increased capacity, which may be beneficial in the event of a malfunction that results in a greater rate of dripping, and is also beneficial in systems that employ a larger bore in the needle tip 106, and so will tend to produce larger drops.

It can be seen, with reference to FIGS. 3A and 3B, that the shutter system 210 is mechanically very simple, and can be adapted to operate with existing dispenser systems relatively inexpensively. Because it is entirely mechanically operated, and is controlled by movement of the dispenser body, it does not require any modification of electronic systems or software operating systems that control operation of the dispenser. In applications where an adhesive dispenser is employed in the assembly of devices like the optical sensors described above, loss of even a small percentage of the products in process can become expensive, and preventing those losses can quickly recover the cost of adding a shutter system to an existing dispenser system.

In prototype tests with a conventional dispenser system, the inventors installed a shutter system that operates substantially as described with reference to the embodiment of FIGS. 3A and 3B, which was employed in assembly of thousands of products over a period of months, during which time damage and loss due to adhesive drips was completely eliminated.

Turning now to FIGS. 4A and 4B, an adhesive dispensing system 230 is shown, according to another embodiment, and that includes a shutter system 240. The shutter system 240 comprises a screw arm 242 to which a shutter 212 is coupled. Rotation of the screw arm 242 moves the shutter 212 between a closed position, as shown in FIG. 4A, and an open position, as shown in FIG. 4B. A first support bracket 244 is coupled to the support fixture 103 and a second support bracket 246 is coupled to the dispenser body 105. The screw arm includes long-lead threads 248 along at least a portion of its length, and is coupled to the first support bracket 244 so as to be rotatable about its own longitudinal axis. A sliding nut 250 is rigidly coupled to the second support bracket 246 and is threaded onto the screw arm 242 so as to engage the threads 248 of the screw arm. Vertical movement of the sliding nut 250 relative to the screw arm 242 compels rotation of the screw arm.

While the dispenser 104 is in the ready position, the screw arm 242 and shutter 212 are in the closed position, as shown in FIG. 4A. When the dispenser 104 moves to the dispensing position, the vertical movement of the dispenser body 105 moves the sliding nut axially along the screw arm 242. The engagement of the nut 250 with the threads 248 of the screw arm 242 causes the screw arm 242 to rotate with respect to the dispenser 104, which rotates the shutter 206 to the open position and out from beneath the needle tip 106, as shown in FIG. 4B. The dispenser 104 is thus able to dispense adhesive as required for the particular process. When the dispenser body 105 returns to the ready position, movement of the nut 250 relative to the screw arm 242 again causes the screw arm to rotate, rotating the shutter 212 back into the closed position.

As with the embodiment described with reference to FIGS. 3A and 3B, the shutter system 240 of the embodiment of FIGS. 4A and 4B is entirely mechanically operated, and controlled by movement of the dispenser body 105 relative to the support fixture 103. However, the shutter system 240 is not dependent upon gravity for operation, but is controlled by the position of the sliding nut 250 relative to the screw arm 242.

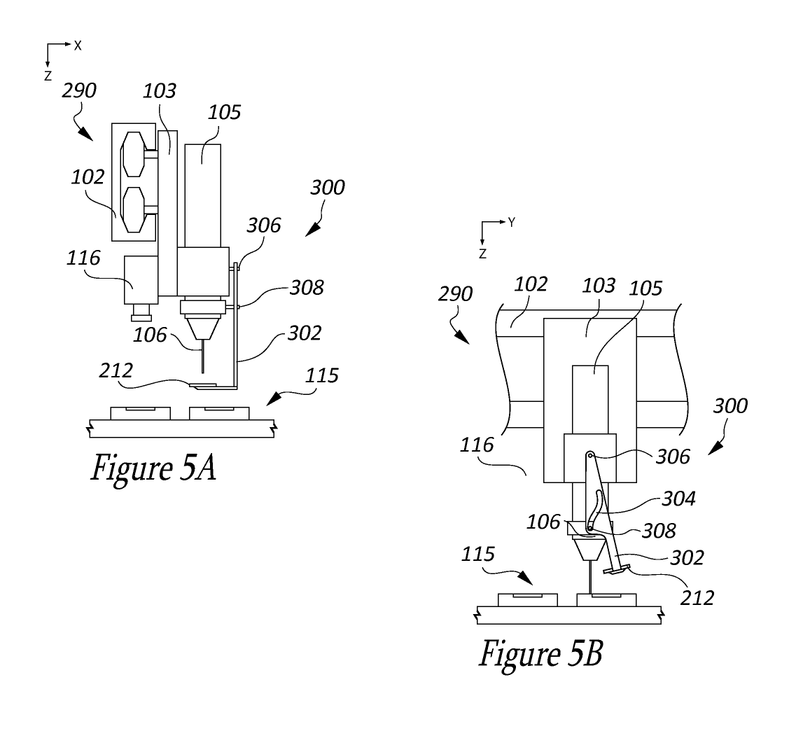

FIGS. 5A and 5B are diagrammatic representations of a dispenser system 290 that includes a shutter system 300. FIG. 5A is a side view of the dispenser system 290 in the ready position, with the shutter system 300 in the closed position. FIG. 5B is a front view of the dispenser system 290 in the dispensing position, with the shutter system 300 in the open position. The shutter system 300 includes a arm 302 that has a cam slot 304 and a shutter 212. The swing arm 302 is rotatably coupled to the support fixture 103 via a pivot pin 306, and constrained by a cam follower 308 that is coupled to the dispenser body 105 and that traverses the cam slot 304.

While the dispenser system 290 is in the ready position, the swing arm 302 hangs from the pivot pin 306 and supports the shutter 212 in the closed position, as shown in FIG. 5A. When the dispenser system 290 moves to the dispensing position, the dispenser body 105, with the cam follower 308 attached, drops toward the working surface 115. As the cam follower 308 moves down the cam slot 304, the shape of the cam slot cooperates with the cam follower to cause the swing arm 302 to rotate around the pivot pin 306, moving the shutter 212 to an open position, as shown in FIG. 5B. Conversely, when the dispenser body 105 moves back to the ready position, the cam slot 304 cooperates with the cam follower 308 to move the shutter 212 back into the closed position under the needle tip 106.

As with previously described embodiments, the embodiment of FIGS. 5A and 5B is mechanically driven, controlled by movement of the dispenser body 105. The position of the swing arm 308 and shutter 212 are positively controlled at any given position of the dispenser body 105 by the intersection of the cam follower 308 and the cam slot 304 at that position.

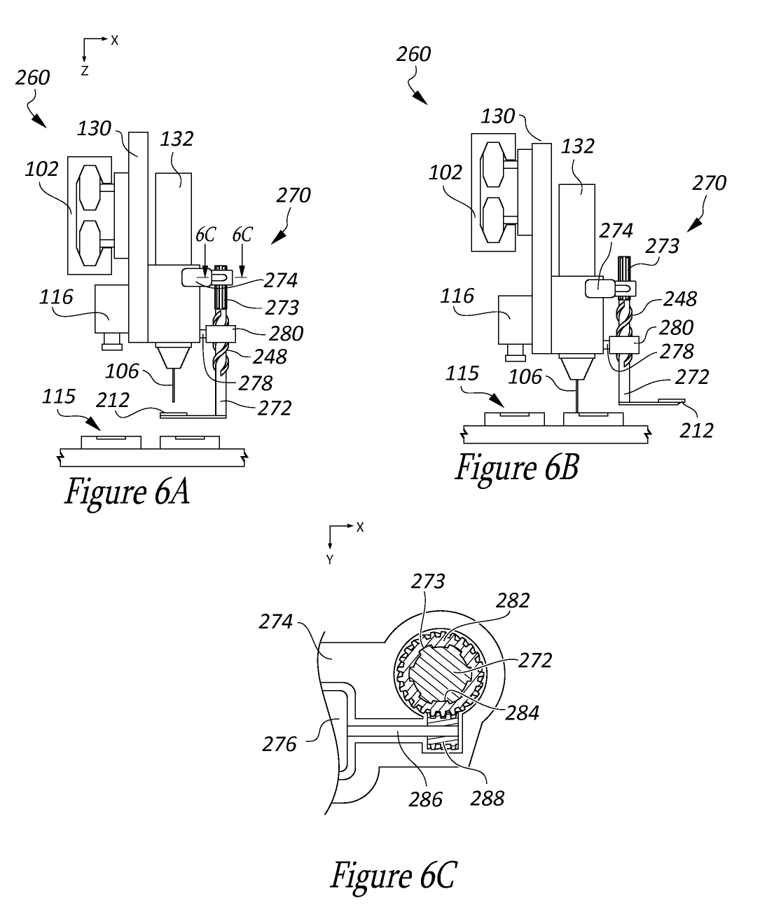

FIGS. 6A-6C are diagrammatic representations of a dispenser system 260 that includes a shutter system 270, according to another embodiment. The dispenser system 260 includes a support fixture 130 to which a dispenser 132 is rigidly coupled. To move the dispenser 132 from the ready position, as shown in FIG. 6A to the dispensing position, as shown in FIG. 6B, the dispenser does not move relative to the support fixture 130, but the support fixture extends downward with the dispenser.

The shutter system 270 includes a screw arm 272 to which the shutter 212 is coupled, the screw arm 272 also includes long-lead threads 248 extending along a portion of its length, and splines 273 extending along a portion of the screw arm at a first end thereof. A first support bracket 274 is coupled to the support fixture 130 and to the first end of the screw arm 272. A motor 276 is coupled to the support fixture 130, and rotationally coupled to the screw arm 262, as will be described in more detail below with reference to FIG. 6C. While the screw arm 272 is rotationally coupled to the motor 272, it is slidably coupled, relative to the motor 272 and support bracket 274. A second bracket 278 is also coupled to the support fixture 130 and rigidly supports a sliding nut 280, which engages the threads 248 of the screw arm 272.

FIG. 6C is a partial cross-sectional view of the first support bracket 274 and screw arm 272, taken along lines 6C-6C of FIG. 6A. The first support bracket 274 supports a splined gear 282 that has a splined aperture 284 through which the first end of the screw arm 272 passes, with the splines 273 of the screw arm engaging the splined aperture of the gear. The motor 276 comprises a motor shaft 286 and a helical drive gear 288, which engages helical gear teeth on the outside of the splined gear 282.

Rotation of the motor 276 is transmitted by the motor shaft 286 and drive gear 288 to the splined gear 282 and thence to the screw arm 272. Rotation of the screw arm 272 applies an axial force to the sliding nut 280, which causes relative axial movement between the screw arm and the sliding nut. Because the first and second support brackets 274, 278 are both rigidly fixed to the support fixture 130, the sliding nut 280, supported by the second support bracket, cannot move relative to the splined gear 274, which is supported by the first support bracket. Thus, when the screw arm 272 rotates, the screw arm itself is compelled to move axially. The splined engagement of the screw arm 272 and the splined gear 282 permits the screw arm to slide within the splined gear while remaining rotationally coupled thereto.

The dispensing system 260 is configured to signal the motor 276 as it initiates movement from the ready position to the dispensing position. The motor 276 is controlled to rotate a preselected number of rotations, which are transmitted to the screw arm 272. Rotation of the screw arm 272 rotates the shutter 212 from the closed position to the open position, and at the same time lifts the screw arm relative to the dispenser 232 and support fixture 130 because of the axial force applied to the sliding nut 280. This raises the shutter 212 a distance that is sufficient to prevent the shutter from striking the working surface as the dispensing system 260 drops to the dispensing position. When the dispensing system 260 returns to the ready position, another signal is sent to the motor 276, which is controlled to rotate in the reverse direction the same number of rotations, to return the screw arm 272 and shutter 212 to the closed position. Various methods for electronic control and timing of the embodiments of FIGS. 6A-8B will be discussed after the detailed description of the structure of the embodiment of FIGS. 8A and 8B

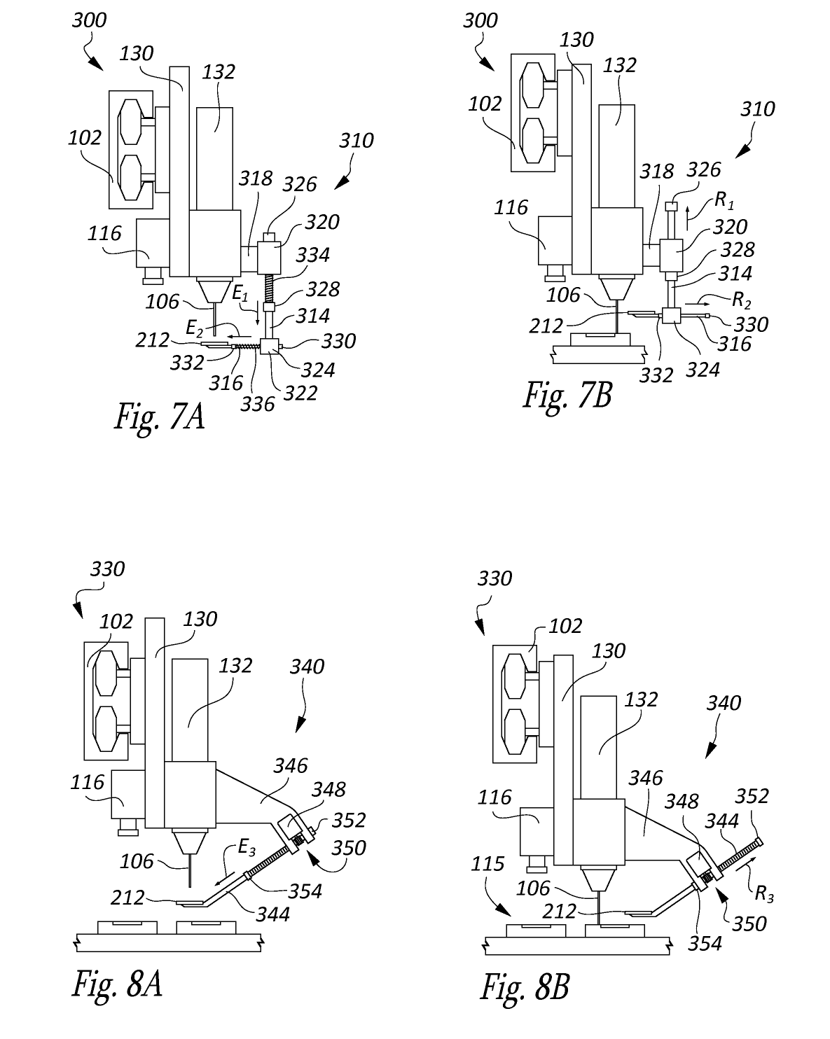

FIGS. 7A and 7B are diagrammatic representations of a dispenser system 300 that includes a support fixture 130, a dispenser 132, and a shutter system 310, according to another embodiment. The support fixture 130 and dispenser 132 of the dispenser system 300 are rigidly coupled, so that, when moving from the ready position to the dispense position, both translate in the Z axis. Thus, as with the embodiment of FIGS. 6A-6C, the shutter 212 must be moved, relative to the dispenser 132 and support fixture 130, in the plane defined by the X and Y axes in order to clear the needle tip 106, and also in the Z axis so as not to strike the working surface as the support fixture 130, to which it is coupled, drops to bring the dispenser system 132 to the dispensing position.

The shutter system 310 includes a first translating arm 314 and a second translating arm 316 to which the shutter 212 is coupled. The first translating arm 314 is slidingly coupled to the support fixture 1 via a first support bracket 318 which also houses a first solenoid 320. The second translating arm 316 is slidingly coupled to the first translating arm 314 via a second support bracket 322 which also houses a second solenoid 324. First and second stops 326, 328 are coupled to the first translating arm 314, and third and fourth stops 330, 332 are coupled to the second translating arm 316. A first extension spring 334 is coupled to the first translating arm 314 between the second stop 328 and the first support bracket 318, and a second extension spring 336 is coupled to the second translating arm 316 between the fourth stop 332 and the second support bracket 322.

The first and third stops 326, 330 limit extension of the first and second translating arms 314, 316, respectively, and the second and fourth stops 328, 332 limit retraction of the first and second translating arms, respectively. The first and second extension springs 334, 336 bias the first and second translating arms 314, 316, toward full extension, as indicated by arrows E₁ and E₂. When energized, the first solenoid 320 applies to the first translating arm 314 a retraction bias, indicated by arrow R₁ in FIG. 7B, and when energized, the second solenoid 324 applies to the second translating arm 316 a respective retraction bias, indicated by arrow R₂ in FIG. 7B.

While the dispenser 132 is in the ready position, the first and second solenoids 320, 324 are not energized, so that the first and second translating arms 314, 316 are maintained in their respective extended positions by the biasing forces of the first and second extension springs 334, 336, and the shutter 212 is maintained in the closed position, as shown in FIG. 7A. When the dispenser begins to move toward the dispensing position, the first and second solenoids 320, 324 are energized, which overcomes the bias of the respective extension springs and causes the first and second translating arms 314, 316 to retract to the limits permitted, respectively by the second and fourth stops 328, 332, moving the shutter 212 to the open position, as shown in FIG. 7B. While the dispenser 132 remains in the dispensing position, the first and second solenoids 320, 324 remain energized to hold the translating arms 314, 316 in their respective retracted positions and maintain the shutter 212 in the open position. When the dispenser system 130 returns to the ready position, the first and second solenoids 320, 324 are de-energized, whereupon the first and second translating arms 314, 316 return to their respective extended positions in response to the bias of the first and second extension springs 334, 336, returning the shutter 212 to the closed position.

Retraction and extension of the first translating arm 314 moves the second translating arm 316 and the shutter 212 in the Z axis, while retraction and extension of the second translating arm moves the shutter in the X axis. According to an embodiment, when moving the shutter 212 from the closed to the open positions, the second translating arm 316 is retracted earlier than the first translating arm 314 so that the shutter 212 is moved laterally beyond the end of the needle tip 106 before the first translating arm lifts the second translating arm and shutter. In contrast, when moving the shutter 212 from the closed to the open positions, the first translating arm 314 is extended before the second translating arm 316 so that the shutter 212 is below the end of the needle tip 106 before the second translating arm extends the shutter toward the closed position.

Provision of timing of, and power for energizing of the first and second solenoids is well within the abilities of one of ordinary skill in the art. Integration of the shutter system 302 with the operation of the dispenser system 300 can be accomplished in a number of different ways, including by methods similar to those discussed with reference to the embodiment of FIGS. 6A-6C.

According to another embodiment, a shutter system is similar in many respects to that described with reference to FIGS. 7A and 7B, but is coupled to an adhesive dispensing system like the dispensing system 200 of FIGS. 3A and 3B in which the support fixture 102 does not translate with the dispenser 104. Thus, provided the shutter system is coupled to the support fixture, there is usually no requirement that the shutter move in the Z axis. In such an application, the first translating arm 314 of the embodiment of FIGS. 7A and 7B need not be slidably coupled to the first support bracket 318, but can be rigidly coupled. Likewise, the first solenoid 320, the first extension spring 334, and the first and second stops 326, 328 can be eliminated. Thus, only the second translating arm 316 retracts when the dispenser of the system moves to the dispensing position.

Turning now to FIGS. 8A and 8B, an adhesive dispensing system 330 is shown, including a dispenser 132 rigidly coupled to a support fixture 130, and a shutter system 340. The shutter system 340 includes a translating arm 344 coupled to a support bracket 346, which also supports a motor 348 coupled to the translating arm via a rack-and-pinion mechanism 350 to control movement of the translating arm. A shutter 212 is coupled to an end of the translating arm 344 and is movable by the arm between closed and open positions corresponding, respectively, to an extended and a retracted position of the translating arm. First and second stops 352, 354 are coupled to the translating arm 344 to limit, respectively, extension and retraction thereof.

While the dispenser 132 is in the ready position, the translating arm 344 is maintained in its extended position with the shutter 212 in the closed position, as shown in FIG. 8A. When the dispenser 132 begins to move to the dispensing position, the motor 348 rotates in a first rotation direction, retracting the translating arm 344 by operation of the rack-and-pinion mechanism 350, as indicated by the arrow R₃ in FIG. 8B, and moving the shutter 212 from the closed position to the open position.

When the dispenser 132 begins to return to the ready position from the dispensing position, the motor 348 rotates in a second rotation direction, opposite the first rotation direction, extending the translating arm 344 by operation of the rack-and-pinion mechanism 350, as indicated by the arrow E₃ In FIG. 8A, and moving the shutter 212 from the open position to the closed position.

Control of operation of the shutter systems 270, 310, and 340, described above with reference to FIGS. 6A-8B, can be provided in a number of different ways, all of which are well within the abilities of one of ordinary skill in the art. For example, according to an embodiment, a control unit for controlling operation of the shutter system 340 of FIGS. 6A-6C is provided, in which first and second limit switches are coupled to the splined gear 282, with a first limit switch configured to close when the screw arm 274 rotates to the closed position, and a second limit switch is configured to close when the screw arm rotates to the open position. A pressure switch, acting as a fixture position detector, is mounted to the robotic arm 102 and configured to close when the support fixture 130 moves to the ready position, and to open as the fixture begins to move away from the ready position. A dedicated logic circuit includes an input coupled to the pressure switch, and is configured to apply a voltage having a first polarity to the motor 276 when the pressure switch is closed unless the first limit switch is also closed, and to apply a voltage having a second polarity to the motor 276 when the pressure switch is open unless the second limit switch is closed. Thus, when the fixture 130 begins to move away from the ready position, the pressure switch opens. Assuming the screw arm 274 is in the closed position, in which the first limit switch is closed, and the second limit switch is open, a voltage will be applied to the motor 276 causing the screw arm 274 to rotate until the second limit switch closes, indicating the shutter is in the open position, at which point the logic circuit will stop the voltage signal. The opposite action will occur when the support fixture 132 returns to the ready position, causing the pressure switch to close, and the motor 276 to rotate in the opposite direction until the first limit switch again closes.

It will be recognized that the simple arrangement described above can be adapted to control the motor 348 of the embodiment of FIGS. 8A and 8B, with limit switches arranged to change states when the translating arm 344 moves, respectively, to and from the extended position, and to and from the retracted position.

With regard to the embodiment of FIGS. 7A and 7B, an embodiment is provided in which a first limit switch is configured to close when the first translating arm 314 is moved to the extended position, and a second limit switch that is configured to close when the second translating arm 616 is moved to the retracted position. The dedicated logic circuit is configured to energize the second solenoid while the pressure switch is open or while the first limit switch is open, and to energize the first solenoid while the pressure switch is open and the second limit switch is closed. Given this arrangement, when the support fixture begins to move away from the ready position and the pressure switch changes values, the logic circuit will first energize the second solenoid, which will retract the second translating arm 316. When the second arm 316 reaches the retracted position, the second limit switch closes, at which point the first solenoid is energized, retracting the first translating arm 314. Both solenoids will remain energized until the fixture 132 returns to the ready position, closing the pressure switch. At this point, the logic circuit will de-energize the first solenoid, permitting the first translating arm 314 to return to its extended position. When the first translating arm 314 reaches its extended position, the first limit switch will open, at which point the second solenoid 324 will be de-energized, permitting the second translating arm 316 to return the shutter to the closed position.

According to other embodiments, the pressure switch is replaced with a sensor, such as, e.g., a proximity or hall-effects sensor, to function as the fixture position detector.

The dispenser system will typically be controlled, perhaps along with other elements of the associated assembly system, by software instructions that are executed by a microprocessor. The microprocessor may be a dedicated processor that is integral to a component of the assembly system, or it may be a general purpose processor that is part of a stand-alone computer system that is coupled to the assembly system. In either case, an instruction to switch from the ready position to the dispensing position will include a change in a logic value at one or more terminals in a control circuit of the dispenser system. According to an embodiment, the input of the dedicated logic circuit is coupled to an appropriate terminal of the control circuit in order to detect the change in a logic value, which replaces the fixture position detector as a means for signaling a change from the ready position to the dispensing position and vice-versa.

Finally, according to an embodiment, the software instructions that control operation of the dispenser system include instructions to provide a first logic value at an input terminal of the dedicated logic circuit to command a change of the shutter system from the closed to the open position, and to provide a second logic value to command a change from the open to the closed position.

In describing the operation of the shutter systems described with reference to FIGS. 6A-8B, each system is described as moving from its respective closed position to open position when the respective adhesive dispenser begins to move from the ready position to the dispensing position. It will be recognized that the actual timing of the movement of the shutter systems can be configured to begin before the dispenser begins to move, or concurrently therewith. In part this will depend on the configuration of the particular system. If movement of a shutter system is signaled by a change of state of a pressure switch coupled to some portion of a dispenser or support fixture to detect initial movement toward the dispensing position, then the shutter system can only begin to move after the dispensing system begins to move. However, if the shutter system is controlled by a signal that corresponds to or is also used as a command signal or enable signal to initiate movement of the dispensing system, then the shutter system can be configured to move concurrently with, or slightly before the dispensing system, depending upon the relative response times of the systems. Furthermore, if, in a software program configured to control operation of both systems, separate code instructs the operation of the shutter system, then the timing of operation can be programmed to meet any preference or requirement. Where the claims refer to movement of the shutter to or from the closed position as being substantially concurrent with movement of the adhesive dispenser, this is to be construed as reading on any movement of the shutter to or from the closed position that corresponds to movement of the dispenser, regardless of which is first to move or first to complete its movement. It thus includes simultaneous movement, but is also broader to include moving concurrently.

The shutter systems of FIGS. 6A-8B have been described with reference to dispensing systems like the system 260 of FIGS. 6A-6C, in which the entire support fixture 130 translates in the Z axis to move the dispenser 132 to the dispensing position. As noted above, such a dispensing system requires a shutter system capable of moving the shutter in the Z axis to avoid contact with the working surface. However, embodiments that have such a capability are not limited to dispensing systems like the system 260, but can also be employed with dispensing systems like the system 200, described with reference to FIGS. 3A and 3B, in which the support fixture 103 does not translate to move the dispenser 104 to the dispensing position, but instead remains at substantially the same position, with respect to the Z axis, while the dispenser translates separately. Movement of the shutter in the Z axis, relative to the support fixture is not generally detrimental to overall operation of the dispenser system. Furthermore, in some applications, it may be preferable to attach a shutter system directly to the dispenser rather than to the support fixture as described in the disclosed embodiments. In that case, even though the support fixture does not translate, it would still be necessary to move the shutter in the Z axis, as described with reference to the embodiments of FIGS. 6A-8B.

While the invention has been described and illustrated primarily with reference to systems for applying adhesive to optical sensors on semiconductor dice, the principles of the invention can be applied with advantage to any system that is employed to automatically dispense adhesive, especially where drops of the adhesive in unintended locations can damage products in process. Accordingly, except where a particular system is explicitly claimed, the claims are not limited in that respect. The term working surface is used to refer broadly to any surface or structure positioned under the nozzle of an adhesive dispenser, particularly in a position where it can receive an adhesive.

Because the drawings are diagrammatic, they are not intended to show details of actual dispensing systems, except where those details are specifically referred to and described. Otherwise, the drawings are intended to convey the function of the elements depicted. In particular, elements of known systems, such as robotic arms, support fixtures, cameras, adhesive dispensers, etc., are well known in the art, and can have any of a large number of shapes and structures, which vary widely according to system, manufacturer, capacity, model, etc. Even the structures that are described in detail are provided as examples of various structures that can be employed, according to the preferences of a user or the limitations imposed by a particular dispensing system.

Most of the drawings are presented as side views of respective dispensing systems, and drawings that show views from other vantage points are defined accordingly. This is used to provide a common point of reference for the drawings, and does not impose any limitations. Furthermore, claim limitations that read on elements that are shown in the drawing as being, for example, positioned in front of an adhesive dispenser, or at the side, are not limited to the position shown.

The unit symbol “μm” is used herein to refer to a value in microns. One micron is equal to 1×10⁻⁶ meters.

Ordinal numbers, e.g., first, second, third, etc., are used according to conventional claim practice, i.e., for the purpose of clearly distinguishing between claimed elements or features thereof. The use of such numbers does not suggest any other relationship, e.g., order of operation or relative position of such elements, nor does it exclude the possible combination of the listed elements into a single, multiple-function, structure or housing. Furthermore, ordinal numbers used in the claims have no specific correspondence to those used in the specification to refer to elements of disclosed embodiments on which those claims read.

Where a claim limitation recites a structure as an object of the limitation, that structure itself is not an element of the claim, but is a modifier of the subject. For example, in a limitation that recites “a shutter system configured to be coupled to an adhesive dispenser system,” the adhesive dispenser system is not an element of the claim, but instead serves to define the scope of the subject term shutter system. Additionally, subsequent limitations or claims that recite or characterize additional elements relative to the adhesive dispenser system do not render the adhesive dispenser system an element of the claim.

The term coupled, as used in the claims, includes within its scope indirect coupling, such as when two elements are coupled with one or more intervening elements even where no intervening elements are recited.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

Elements of the various embodiments described above can be combined, and further modifications can be made, to provide further embodiments without deviating from the spirit and scope of the invention. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

1. A device, comprising:
a shutter system configured to be coupled to an adhesive dispensing system adjacent to an adhesive dispenser of the adhesive dispensing system, the shutter system including:
an arm configured to be coupled to the adhesive dispenser system so as to be movable relative to the adhesive dispenser, and
a shutter coupled to the arm and movable therewith between a closed position, in which the shutter is interposed between a nozzle of the adhesive dispenser and a working surface, and an open position, in which the shutter is not interposed between the nozzle and the working surface.

2. The device of claim 1 wherein the shutter system comprises means for moving the shutter to the closed position when the adhesive dispenser is moved from a dispensing position to a ready position, and means for moving the shutter to the open position when the adhesive dispenser is moved from the ready position to the dispensing position.

3. The device of claim 1 wherein the arm is configured to be coupled to the adhesive dispensing system at a pivot point so as to be rotatable, relative to the adhesive dispensing system, about a first axis that lies substantially perpendicular to a second axis along which the adhesive dispenser is configured to move between a ready position and a dispensing position, a range of motion of the arm about the first axis including a position in which the shutter is in the closed position, and apposition in which the shutter is in the open position.

4. The device of claim 3 wherein weight distribution of the arm is such that, absent external influences, the arm will hang from the pivot point with the shutter away from the closed position, the shutter system further comprising a bumper positioned so that movement of the adhesive dispenser from the dispensing position toward the ready position brings the adhesive dispenser into contact with the bumper, and movement of the adhesive dispenser to the ready position causes the arm to rotate the shutter to the closed position.

5. The device of claim 4 wherein the shutter system further comprises a stop pin configured to be rigidly coupled to a support fixture of the adhesive dispensing system in a position to arrest movement of the arm at a position at which the shutter is in the open position.

6. The device of claim 3 wherein the arm comprises a cam slot and the shutter system comprises a cam follower pin configured to be rigidly coupled to the adhesive dispenser positioned so as to traverse the cam slot of the arm and to follow the cam slot as the adhesive dispenser moves between the ready position and the dispensing position, a shape of the cam slot being selected to cooperate with the follower pin to move the shutter to the closed position as the adhesive dispenser moves to the ready position, and to move the shutter to the open position as the adhesive dispenser moves to the dispensing position.

7. The device of claim 1 wherein the arm is configured to be coupled to a support fixture of the adhesive dispensing system so as to be rotatable, relative to the adhesive dispensing system, about an axis that lies substantially parallel to an axis along which the adhesive dispenser is configured to move between a ready position and a dispensing position, the arm having screw threads along a portion of a length thereof, the shutter system further comprising a sliding nut configured to be rigidly coupled to the adhesive dispenser with the arm traversing the nut, the nut having internal threads configured to engage the screw threads of the arm so that movement of the adhesive dispenser relative to the arm causes the nut to slide axially along the arm, and engagement of the internal threads of the nut with the screw threads of the arm causes the arm to rotate as the adhesive dispenser moves, the shutter being coupled to the arm so as to be rotated into the closed position when the adhesive dispenser moves to the ready position, and away from the closed position as the adhesive dispenser moves away from the ready position.

8. The device of claim 1 wherein the arm is configured to be coupled to the adhesive dispensing system so as to be rotatable, relative to the adhesive dispensing system, about a first axis that lies substantially parallel to a second axis along which the adhesive dispenser is configured to move between a ready position and a dispensing position, and also to move axially along the first axis relative to the adhesive dispensing system, the arm having screw threads along a portion of a length thereof, the shutter system further comprising a sliding nut configured to be rigidly coupled relative to the adhesive dispenser with the arm traversing the nut, the nut having internal threads configured to engage the screw threads of the arm so that rotation of the arm relative to the nut applies an axial bias to the arm, causing the arm to move axially, relative to the adhesive dispenser, as it rotates.

9. The device of claim 8 wherein the shutter system comprises means for rotating the arm, relative to the adhesive shutter system, while permitting axial movement of the arm.

10. The device of claim 8 wherein the arm comprises splines along another portion thereof, the shutter system comprising:
a gear having a splined aperture and being configured to be rotatably coupled to the adhesive dispensing system with the splines of the arm engaging splines in the splined aperture;
a motor configured to be coupled to the adhesive dispensing system and having an output shaft; and
a drive gear coupled to the output shaft and engaging the splined gear so that rotation of the motor is transmitted to the arm.

11. The device of claim 1 wherein the arm is configured to be translatably coupled to the adhesive dispensing system so as to be translatable along a first axis that lies at an angle relative to a second axis along which the adhesive dispenser is configured to move between a ready position and a dispensing position, the shutter being coupled to the arm so that extension of the arm along the first axis, while the shutter system is coupled to the adhesive dispensing system, moves the shutter into the closed position, and retraction of the arm moves the shutter away from the closed position.

12. The device of claim 11 wherein the shutter system comprises a motor, and a rack-and-pinion mechanism by which the shutter system is configured to be coupled to the adhesive dispensing system, the motor being coupled to the rack-and-pinion mechanism such that rotation of the motor in a first direction compels the arm to move the shutter toward the closed position and rotation of the motor in a second direction opposite the first direction compels the arm to move the shutter away from the closed position.

13. The device of claim 11 wherein the arm is a first arm, and the first axis lies substantially perpendicular to the second axis, the shutter system further comprising a second arm configured to be translatably coupled to the adhesive dispensing system so as to be translatable along a third axis that lies substantially parallel to the second axis and perpendicular to the first axis, the first arm being translatably coupled to the second arm so as to be translatable, relative to the second arm, along the first axis, the first arm being configured to be coupled to the adhesive dispensing system via the second arm.

14. A method, comprising:
applying adhesive from an adhesive dispenser to a working surface;
moving the adhesive dispenser from a dispensing position to a ready position;
substantially concurrently with moving the adhesive dispenser to the ready position, moving a shutter to a closed position, in which the shutter is interposed between a nozzle of the adhesive dispenser and the working surface;
while the adhesive dispenser is in the ready position, catching drops of adhesive from the nozzle of the adhesive dispenser on the shutter;
moving the adhesive dispenser toward the dispensing position; and
before the adhesive dispenser reaches the dispensing position, moving the shutter away from the closed position.

15. The method of claim 14 wherein movement of the shutter away from between the nozzle and the underlying surface comprises rotating the shutter about an axis that lies substantially perpendicular to an axis along which the dispenser moves between the ready and the dispensing positions.

16. The method of claim 15 wherein moving the adhesive dispenser from a dispensing position to a ready position comprises contacting a bumper with the adhesive dispenser as the dispenser approaches the ready position, the bumper being coupled to the shutter so that, as the dispenser moves into the ready position, movement of the bumper causes the shutter to rotate away from the closed position.

17. The method of claim 14 wherein movement of the shutter away from between the nozzle and the underlying surface comprises rotating the shutter about an axis that lies substantially parallel to an axis along which the dispenser moves between the ready and the dispensing positions.

18. The method of claim 14 wherein movement of the shutter away from between the nozzle and the underlying surface comprises moving the shutter along a first axis that lies substantially parallel to a second axis along which the dispenser moves between the ready and the dispensing positions, and also along a third axis that lies substantially perpendicular to the second axis.

19. The method of claim 14 wherein movement of the shutter away from between the nozzle and the underlying surface comprises moving the shutter along a first axis that lies substantially parallel to a second axis along which the dispenser moves between the ready and the dispensing positions, and also along a third axis that lies substantially perpendicular to the second axis.

20. A system, comprising:
an adhesive dispenser having a nozzle for dispensing adhesive;
a support structure configured to support the adhesive dispenser above a working surface, to move the adhesive dispenser in two axes over the working surface, and to raise and lower the adhesive dispenser in a third axis between a dispensing position and a ready position; and
a shutter coupled to the support structure and configured to move between a closed position, in which the shutter is interposed between the nozzle and the working surface, and an open position, in which the shutter is not between the nozzle and the working surface.

21. The system of claim 19, comprising an arm, coupled to the support structure, and to which the shutter coupled, the arm configured to move the shutter between the open and closed positions.

22. The system of claim 20 wherein the arm and shutter are configured to rotate about a fourth axis that lies parallel to the third axis.

23. The system of claim 20 wherein the arm and shutter are configured to rotate about a fourth axis that lies perpendicular to the third axis.

24. The system of claim 20 wherein the arm is rotatably coupled to the support structure at a pivot point, the arm having a bumper extending over the adhesive dispenser and positioned so as to contact the adhesive dispenser as the dispenser moves from the dispensing position toward the ready position, and to cause the arm to rotate the shutter into the closed position when the dispenser moves to the closed position, a balance of the arm, bumper, and shutter being selected so that while the dispenser is not in contact with the bumper, the arm rotates the shutter away from the closed position under the influence of gravity.
